(19) United States
(12) Patent Application Publication
(10) Pub. No.: US 2024/0412480 A1
(43) Pub. Date: Dec. 12, 2024

(54) IMAGE SEGMENTATION LABEL GENERATION METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Jie Wu, Beijing (CN); Jie Qin, Beijing (CN); Xuefeng Xiao, Beijing (CN)

(21) Appl. No.: 18/717,619

(22) PCT Filed: Dec. 1, 2022
(86) PCT No.: PCT/CN2022/136010

§ 371 Date: Jun. 7, 2024

(30) Foreign Application Priority Data
Dec. 9, 2021 (CN) 202111500780.2

(51) Int. Cl. G06V 10/26; G06V 10/764; G06V 10/771; G06V 10/774; G06V 10/776; G06V 10/82

(52) U.S. Cl. CPC G06V 10/26; G06V 10/764; G06V 10/771; G06V 10/774; G06V 10/776; G06V 10/82

(57) ABSTRACT

Provided in the present disclosure are an image segmentation label generation method and apparatus, and an electronic device and a storage medium. The image segmentation label generation method includes: acquiring a feature map of an original image, determining a feature response map of the feature map, wherein a response value in the feature response map represents a weight of a corresponding feature in the feature map in image classification; increasing a response value within a preset range in the feature response map, reconstructing the feature map according to a feature response map with the increased response value; determining a first-class activation mapping based on the first reconstructed feature map, and determining an image segmentation label according to the first-class activation mapping.

### CROSS-REFERENCE TO RELATED APPLICATION

The present application claims the priority of the Chinese patent application 202111500780.2 filed with the China National Intellectual Property Administration on Dec. 9, 2021, the entire contents of which are hereby incorporated by reference.

### TECHNICAL FIELD

The present disclosure relates to the field of computer technology, for example, to an image segmentation label generation method, an apparatus, an electronic device, and a storage medium.

### BACKGROUND

The image semantic segmentation technique is a technique that implements pixel-wise classification prediction with semantic attributes as a dividing criterion. Image semantic segmentation derives the semantic and positional coordinates of each object in the image, making it of great utility in many fields unfolding around scene understanding.

Since segmentation labels at the pixel level are difficult to acquire, coarse-grained class labels are commonly used as segmentation labels for weakly supervised learning of image semantic segmentation networks. In the related art, a Class Activation Mapping (CAM) of a feature map in an image classification network is generally taken as a segmentation label.

Disadvantages of the related art include, at least, that the response region in the class activation map is a region that is highly correlated with the classification of the discriminated object and does not cover the entire region of the object. The CAM is adopted as the segmentation label, resulting in lower accuracy of the segmentation label, thereby making the training effect of the image semantic segmentation network poorer.

### SUMMARY

The present disclosure provides an image segmentation label generation method, an apparatus, an electronic device and a storage medium, capable of generating a segmentation label with high precision, which is advantageous for optimizing the training effect of an image semantic segmentation network.

In a first aspect, the present disclosure provides an image segmentation label generation method, including:
acquiring a feature map of an original image, determining a feature response map of the feature map, wherein a response value in the feature response map represents a weight of a corresponding feature in the feature map in image classification;
increasing a response value within a preset range in the feature response map, reconstructing the feature map according to a feature response map with the increased response value;
determining a first-class activation mapping based on the reconstructed feature map, and determining an image segmentation label according to the first-class activation mapping.

In a second aspect, the present disclosure further provides an image segmentation label generation apparatus, including:
a response map determination module, configured for acquiring a feature map of an original image, determining a feature response map of the feature map, wherein a response value in the feature response map represents a weight of a corresponding feature in the feature map in image classification;
a feature map reconstruction module, configured for increasing a response value within a preset range in the feature response map, reconstructing the feature map according to a feature response map with the increased response value;
a segmentation label determination module, configured for determining a first-class activation mapping based on the reconstructed feature map, and determining an image segmentation label according to the first-class activation mapping.

In a third aspect, at least one embodiment of the present disclosure provides an electronic device. The electronic device includes:
one or more processors; and
a storage apparatus configured to store one or more programs,
the one or more programs, when executed by the one or more processors, causing the one or more processors to implement the image segmentation label generation method according to any one of embodiments of the present disclosure.

At a fourth aspect, at least one embodiment of the present disclosure provides a storage medium including computer-executable instructions. The computer-executable instructions, when executed by a computer processor, configured to perform the image segmentation label generation method according to any one of embodiments of the present disclosure.

### BRIEF DESCRIPTION OF DRAWINGS

FIG. 1 is a flowchart diagram illustrating an image segmentation label generation method according to an embodiment of the present disclosure;

FIG. 2 is a graph comparing a response value before and after modulation in the image segmentation label generation method according to embodiment 1 of the present disclosure;

FIG. 3 is a schematic diagram of determining a feature response map in the image segmentation label generation method according to embodiment 2 of the present disclosure;

FIG. 4 is a schematic diagram of determining a segmentation label in the image segmentation label generation method according to embodiment 3 of the present disclosure;

FIG. 5 is a structural diagram of an image segmentation label generation apparatus according to embodiment 4 of the present disclosure;

FIG. 6 is a structural schematic diagram of an electronic device provided by Embodiment 5 of the present disclosure.

### DETAILED DESCRIPTION

Embodiments of the present disclosure will be described below with reference to the accompanying drawings. While some embodiments of the present disclosure are shown in the drawings, the present disclosure may be embodied in many forms, with these embodiments being provided to provide an understanding of the present disclosure. The figures and examples of the present disclosure are intended to be exemplary only.

The multiple steps recited in the method implementation of the present disclosure may be performed in a different order, and/or in parallel. Further, the method implementation may include additional steps and/or omit performing illustrated steps. The scope of the present disclosure is not limited in this regard.

As used herein, the term “include” and variations thereof are open inclusion, that is, “including, but not limited to”. The term “based on” is “based at least in part on.” The term “one embodiment” means “at least one embodiment”; the term “another embodiment” means “at least one additional embodiment”; the term “some embodiments” means “at least some embodiments”. Relevant definitions for other terms will be given in the description below.

The concept of “first,” “second,” and the like mentioned in the present disclosure is only used to distinguish different apparatus, modules, or units, and is not used to limit the order or interdependence of functions performed by these apparatus, modules, or units.

Modifications referred to in this disclosure as “a”, “a plurality” are intended to be illustrative rather than limiting, and it should be understood by those skilled in the art that “one or more” should be understood unless the context dictates otherwise.

### Embodiment 1

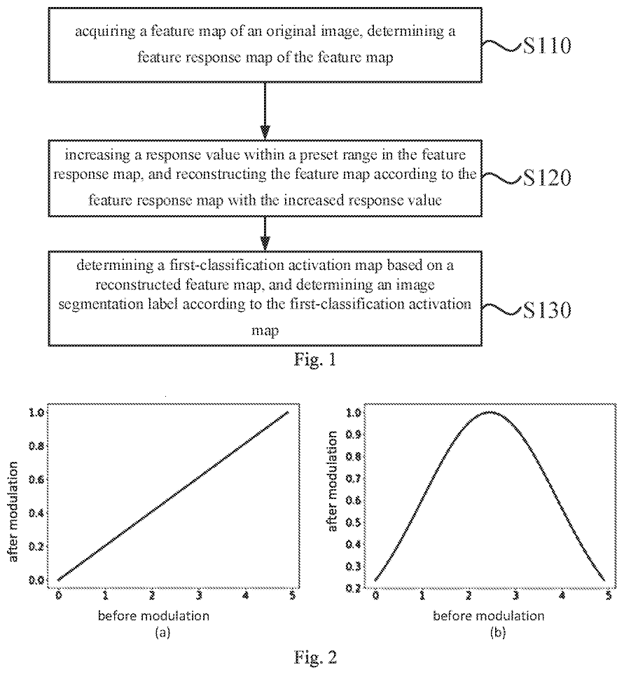

FIG. 1 is a flowchart illustrating an image segmentation label generation method according to an embodiment of the present disclosure, which is applicable to a case where the image segmentation label is generated, and particularly, to a case where the image segmentation label is generated according to a class activation mapping. The method may be performed by an image segmentation label generation apparatus, which may be implemented in software and/or hardware, and the apparatus may be arranged in an electronic device, for example in a computer.

As shown in FIG. 1, the image segmentation label generation method provided by the present embodiment may include:

S110, acquiring a feature map of an original image, determining a feature response map of the feature map.

In an embodiment of the present disclosure, the feature map of the original image may be an image derivative value for representing the nature of the original image determined for performing the task of computer image classification, and the feature map is generally required to have homogeneous image invariance and heterogeneous image discrimination. The feature map may be obtained by dimensionality reduction extraction of the original image, and a common feature map extraction method may include, but is not limited to, an extraction manner based on a convolutional neural network.

The feature response map of the feature map may represent the association degree value between the feature in the feature map and the current classification result, i.e., may reflect the sensitivity of the feature. Therein, the response values in the feature response map may represent the weights of the corresponding features in the feature map in image classification. The larger the response value in the feature response map, it can be considered that the larger the weight of the corresponding feature in the feature map to the image classification, the higher the sensitivity of the feature, and the higher the association degree with the current classification result. The weights of the feature values in the feature map may be determined according to the spatial transformation between the current classification result and the feature map, and the feature response map of the feature map may be determined according to the weights.

S120, increasing a response value within a preset range in the feature response map, and reconstructing the feature map according to the feature response map with the increased response value.

The preset range belongs to a numerical range of the response value in the feature response map. The response value within a preset range may represent the response value corresponding to a feature having a medium weight for image classification but a higher weight for image segmentation. The feature having a medium weight for image classification but a higher weight for image segmentation can be considered as a feature with a high association degree with image segmentation but a little lower association degree with image classification.

The maximum value and minimum value of the preset range may be obtained by supervised learning of the network in advance or may be set according to experimental or empirical values. In an implementation, since the feature response maps of different feature maps are different, the maximum value and minimum value of the preset range may be different. In another implementation, after obtaining the feature response maps for the different feature maps, the feature response maps may be normalized, in which case the minimum value and maximum value of the preset range may be fixed values.

Increasing the response value within the preset range in the feature response map may include any one of the following: uniformly adjusting the response value within the preset range to a preset value; adjusting the response value within the preset range to different segmentation values; adjusting the response values within the preset range to different numerical values one by one. For example, adjusting the response values within the preset range to different numerical values one by one may include, the smaller the response value, the larger the ratio of the difference between the response values before and after the adjustment to the original response value, the larger the response, the smaller the ratio of the difference between the response values before and after adjustment to the original response value. By increasing the response value within the preset range in the feature response map, boosting a weight of a feature that is highly associated with image segmentation but is somewhat less associated with image classification.

The feature response map with the increased response value may refer to the feature response map after increasing the response value within the preset range. Reconstructing the feature map according to the feature response map with the increased response value may be performed by weighting the original feature map by the feature response map to obtain the reconstructed feature map. By reconstructing the feature map based on the feature response map after increasing the response value within the preset range, it is possible to mine features that are easily ignored in the image classification task but are very important for the image segmentation task.

S130, determining a first-class activation mapping based on a reconstructed feature map, and determining an image segmentation label according to the first-class activation mapping.

In an embodiment of the present disclosure, a Class Activation Mapping (CAM) belongs to a feature response map, and the Class Activation Mapping may be considered as a feature response map corresponding to a feature map of the highest level. Multi-level downsampling may be performed on the input original image to extract feature images of different levels. Higher level feature images may have more semantic information and lack spatial information; lower-level feature images may have more fine spatial information and lack semantic information. The spatial information may be a mutual spatial position or a relative directional relationship between a plurality of objects in the image, and the semantic information may be a semantic attribute of an object contained in the image.

The feature map of the highest level may be determined based on the reconstructed feature map of the lower level, and the weights of the feature values in the feature map of the highest level may be determined based on the spatial transformation between the current classification result and the feature map of the highest level, and the first-class activation mapping may be determined based on the weights.

An image segmentation label may be determined from the first-class activation mapping, relating to the modulation of the response value in the feature response map. For example, case one, only the response value within the preset range in the feature response map is increased. In this case, the features corresponding to the response values within the preset range and the original larger response values are associated to a higher degree with the image classification, and the determined first-class activation mapping may highlight a more complete region of the object to be identified. At this point, the first-class activation mapping may be directly taken as an image segmentation label.

As another example, in case 2, the response values in the preset range of the feature response map are increased while the response values in a range other than the preset range are suppressed. In this case, only the features corresponding to the response values within the preset range have a high association degree with the image classification, and the determined first-class activation mapping may highlight the less important region in the object to be recognized. At this point, in order to ensure that the first-class activation mapping can cover the complete region of the object to be identified, calibrating the first-class activation mapping to obtain an image segmentation label.

In some implementations, after determining the image segmentation labels, training the image semantic segmentation network with the image segmentation labels. The image semantic segmentation network may be applied to many fields surrounding scene understanding, such as the field of autonomous driving, and the network may be implemented to assist vehicles in automatically recognizing objects such as pedestrians, vehicles, etc. in a road. It has been experimentally determined that network training based on image segmentation labels generated by the method provided by embodiments of the present disclosure achieves very good training results that not only outperform training using image-level supervision, but even better than some training using saliency map supervision.

In some implementations, increasing a response value within a preset range in the feature response map may include: modulating the feature response map based on a preset modulation function to increase the response value within the preset range in the feature response map.

The preset modulation function may include, but is not limited to, a square wave function, a Gaussian function, and a wavelet function, among others. Illustratively, FIG. 2 is a graph comparing before and after response value modulation in an image segmentation label generation method according to an embodiment of the present disclosure. Both abscissas in (a) and (b) in FIG. 2 may represent response values in the feature response map before modulation, and both ordinates may represent response values in the feature response map after modulation. Therein, the (a) in FIG. 2 shows a front-to-back plot of simple linearly mapped feature response values and the (b) in FIG. 2 shows a front-to-back plot of Gaussian function modulated feature response values.

Taking the preset modulation function as Gaussian function as an example, modulating the feature response map based on the preset modulation function to map all response values to one Gaussian distribution may be expressed by the following formula:

$${A}_{} = ( {{A}_{f}}_{} )$$

Where [symbol] ( ) may denote a Gaussian function, [symbol] _{A}_{_{f}} may denote a pre-mapped response value, and [symbol] _{A} may denote a post-mapped response value. Where the parameter mean μ and standard deviation σ in the Gaussian function may be calculated from the input [symbol] _{A}_{_{f}}, the procedure may be as follows:

$$μ = \frac{1}{M} {\sum }_{i = 1}^{M} ( {𝒱}_{{A}_{f}}^{i} ) \\ σ = \sqrt{\frac{1}{M} {\sum }_{i = 1}^{M} {( {𝒱}_{{A}_{f}}^{i} - μ )}^{2}}$$

Where i may represent the sequence number of the current response value in the feature response map, [symbol] may represent the current response value of the mapper, and M may represent the total number of response values in the feature response map.

Referring again to (b) in FIG. 2, it can be observed that the Gaussian function improves the second significant response value, and the penalty suppresses the highest and lowest response values. This facilitates the extraction of feature regions that are highly associated with image segmentation but easily ignored by the neural network of image classification. Using the modulation function to reorder the response values, increasing the response values of the less significant features, allowing the corresponding easily ignored features to be highlighted.

In these implementations, by modulating the response values in the feature response map by a suitable preset modulation function, the response values within the preset range can be enhanced to highlight features that are important in image segmentation. In addition, response values that are not within the preset range may be weakened. Increasing the response value within a preset range in the feature response map can be achieved by presetting the modulation function.

In some implementations, reconstructing the feature map according to the feature response map with the increased response value may include: expanding the feature response map with the increased response value to have the same resolution as the feature map; and performing pixel-level multiplication on the feature map and the feature response map with the increased response value after expanding resolution.

In these implementations, the feature response map with the increased response value may be resolution expanded in an upsampling manner to have a resolution equal to the resolution of the feature map. After resolution expansion of the feature response map with the increased response value, a pixel-level multiplication with the feature map may be performed to obtain a reconstructed feature map. Exemplarily, the reconstructed feature response map may be computed by the formula F′(I)=Ã⊙F(I), where Ã denotes the feature response map after expanding resolution, F(I) denotes the feature map, and F′(I) denotes the reconstructed feature map.

The technical solution of an embodiment of the present disclosure, acquiring a feature map of an original image, determining a feature response map of the feature map; response values in the feature response map representing weights of corresponding features in the feature map in image classification; increasing a response value within a preset range in the feature response map, reconstructing the feature map based on the feature response map with the increased response value; determining a first-class activation mapping based on the reconstructed feature map, and determining an image segmentation label from the first-class activation mapping.

Modulating the feature response map by increasing the response values within the preset range in the feature response map enables increasing the weight of the feature that is highly associated with image segmentation but are easily ignored by the neural network for image classification. It is possible to cover the complete object region and obtain a high-precision segmentation label by reconstructing the feature map based on the modulated feature response map and generating the class activation mapping according to the reconstructed feature map. In turn, the image semantic segmentation network is trained based on this high-precision segmentation label, advantageously optimizing the training effect of the network.

### Embodiment 2

The embodiments of the present disclosure may be combined with the schemes in the image segmentation label generation method provided in the above embodiments. The method of generating an image segmentation label according to the present embodiment describes the step of determining a feature response map. By pooling, convolution in the spatial dimension, the weight of each channel in the feature map in the channel dimension may be derived, i.e. a first feature response map; by pooling, convolution in the channel dimension, it is possible to derive weight for each region in the feature map in the spatial dimension, i.e. to obtain a second feature response map.

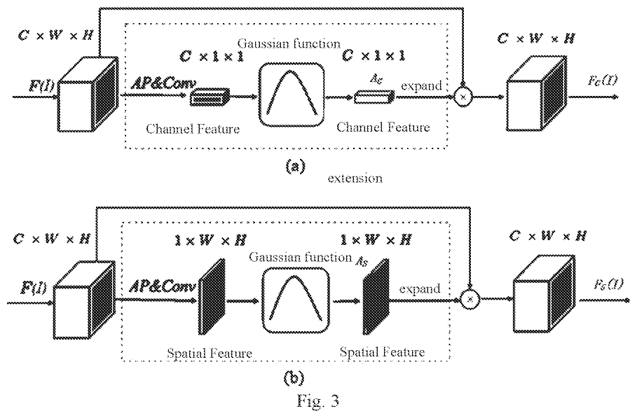

FIG. 3 is a schematic diagram illustrating determining a feature response map in an image segmentation label generation method according to Embodiment 2 of the present disclosure. As shown in FIG. 3, the manner in which the feature response map is determined in the image segmentation label generation method provided by the present embodiment may include any one of the following:

The first mode as shown in (a) of FIG. 3 may perform global average pooling and convolution in the spatial dimension to obtain a first feature response map in the channel dimension.

Referring to (a) in FIG. 3, the size of feature map F(I) may be C×W×H; where C may denote the number of channels, W may denote the width of the feature map, and H may denote the height of the feature map, in the following dimension expressions in the same format, each dimension represents the meaning, which can be referred to here. A global Average Pooling (AP) and Convolution (Conv) processing of the spatial dimension may be performed on F(I), to obtain a first feature response map (Channel feature) of the channel dimension. Due to the pooling of the spatial dimension, the size of the first feature response map may be C×1×1, so that the weight of each channel may be derived.

Referring again to (a) in FIG. 3, the first feature response map (Channel feature) may be modulated with a Gaussian function to reorder the first feature response map, increasing the response value within the preset range, i.e., increasing the weight of the feature map of the preset channel. The feature response map with the increased response value may be represented by A_{c} (Channel attention), and the size of A_{c} is the same as the size of the first feature response map. For example, A_{c} may be calculated by the following formula: A_{c}= [symbol] (H(Pₛ(F(I)))), where [symbol] ( ) may denote a Gaussian function, H( ) may denote a convolution processing, and Pₛ( ) may denote a spatial average pooling function. A_{c} may be multiplied with F(I) at pixel level (represented by multiplication sign in the circle in the figure) after expansion processing, and the reconstructed feature map F_{c}(I) is obtained, and the size of F_{c}(I) is of the same size as C×W×H. For example, F_{c}(I) may be calculated by the following formula: F_{c}(I)=Ã_{c}⊙F(I), where Ã_{c} may denote the A_{c} after expanding resolution.

Modulation of the channel dimension may be achieved by modulating the first feature response map with a Gaussian function, allowing extraction of channel features that are highly associated with image segmentation but are easily ignored by neural networks for image classification.

The second mode as shown in (b) of FIG. 3 may perform global average pooling and convolution processing of the channel dimension on the feature map to obtain the second feature response map of the spatial dimension.

Referring to (b) in FIG. 3, the size of the feature map F(I) may be C×W×H. A second feature response map (Spatial feature) of the spatial dimension may be obtained via AP and Conv processing in the channel dimension. Due to the pooling in the channel dimension, the size of the second feature response map may be 1×W×H, so that the weight for each region may be derived.

Referring again to (b) in FIG. 3, the second feature response map (Spatial feature) may be modulated with a Gaussian function to reorder the second feature response map to increase the response value within the preset range, i.e., increase the weight of the feature map of the preset region. The feature response map with the increased response value may be denote as Aₛ, and the size of Aₛ is the same as the size of the second feature response map. For example, Aₛ may be calculated by the following formula: Aₛ= [symbol] (H(P_{c}(F(I)))), where [symbol] ( ) may denote Gaussian function, H( ) may denote a convolution processing, and P_{c}( ) may denote a channel average pooling function. Aₛ may be multiplied with F(I) at pixel level (represented by multiplication sign in the circle in the figure) after expansion processing, and the reconstructed feature map Fₛ(I) is obtained. For example, Fₛ(I) may be calculated by the following formula: Fₛ(I)=Ãₛ⊙F(I), where Ãₛ may denote the Aₛ after expanding resolution.

Modulation of the second feature response map by a Gaussian function enables modulation in the spatial dimension, allowing extraction of spatial features that are highly relevant to image segmentation but are easily ignored by a neural network for image classification.

In some implementations, if the feature response map is the first feature response map, determining the first-class activation mapping based on the reconstructed feature map, may include: determining a third feature response map in the spatial dimension corresponding to the reconstructed feature map; increasing a response value within the preset range in the third feature response map, reconstructing the reconstructed feature map again based on the third feature response map with the increased response value; determining a first-class activation mapping based on the again reconstructed feature map.

In these implementations, if the feature response map is a first feature response map, firstly, response values within the preset range in the first feature response map may be increased, and the feature map may be reconstructed based on the first feature response map with the increased response value; secondly, a third feature response map in the spatial dimension corresponding to the reconstructed feature map may be determined; the response value within the preset range in the third feature response map may be increased again, and the reconstructed feature map may be reconstructed again based on the third feature response map with the increased response value; finally, a first-class activation mapping is determined based on the again reconstructed feature map. Thus, the channel-dimensional modulation of the feature response map followed by the spatial-dimensional modulation can be achieved so that the feature response map can enhance feature regions in both channel and spatial dimensions that are easily ignored by the neural network for image classification, improving the accuracy of the image segmentation label.

In some implementations, if the feature response map is the second feature response map, determining the first-class activation mapping based on the reconstructed feature map may include: determining a fourth feature response map in the channel dimension corresponding to the reconstructed feature map; increasing a response value within the preset range in the fourth feature response map, reconstructing the reconstructed feature map again based on the fourth feature response map having the increased response value; determining the first-class activation mapping based on the again reconstructed feature map.

In these implementations, if the feature response map is the second feature response map, firstly, response values within the preset range in the second feature response map may be increased, and the feature map may be reconstructed based on the second feature response map with the increased response values; secondly, the fourth feature response map in the channel dimension corresponding to the reconstructed feature map may be determined; the response values within the preset range in the fourth feature response map may be increased again, and the reconstructed feature map may be reconstructed again based on the fourth feature response map with the increased response values; finally, the first-class activation mapping is determined based on the again reconstructed feature map. Therefore, the feature response map can be modulated in the spatial dimension first, and then in the channel dimension, so that the feature response map can enhance the feature regions that are easily ignored by the neural network of image classification in the spatial and channel dimensions, and improve the accuracy of image segmentation label.

In the embodiments described above, no matter the modulation in the channel dimension or the modulation in the spatial dimension, the effect is the same, which can make the feature response map enhance the feature regions that are easily ignored by the neural network of image classification in the spatial and channel dimensions, and improve the accuracy of image segmentation label.

The technical solution of the embodiment of the present disclosure, the determination step of the feature response map is described. By pooling, convolution in the spatial dimension, the weight of each channel in the feature map in the channel dimension can be derived, i.e. the first feature response map; by pooling, convolution in the channel dimension, it is possible to derive weight for each region in the feature map in the spatial dimension, i.e. to obtain a second feature response map. Moreover, after increasing the feature response map in any one of the channel dimension and the spatial dimension, and obtaining the reconstructed feature map according to the feature response map with the increased response value, the feature response map can also be increased in the other dimension, so that the feature response map can enhance the feature regions easily ignored by the neural network of image classification in both the channel dimension and the spatial dimension, and improve the accuracy of image segmentation label.

In addition, the image segmentation label generation method provided by the embodiment of the present disclosure belongs to the same concept as the image segmentation label generation method provided by the above embodiment, technical details that are not elaborately described in the present embodiment may be referred to the above embodiment, and the same technical features have the same effects in the present embodiment and the above embodiment.

### Embodiment 3

The embodiments of the present disclosure may be combined with the schemes in the image segmentation label generation method provided in the above embodiments. The image segmentation label generation method according to the present embodiment describes a first-class activation mapping and a step of generating an image segmentation label. The accuracy rate of the first-class activation mapping can be improved by reconstructing the feature map in the channel dimension and/or the spatial dimension level-by-level to obtain the feature map of the highest level, and determining the first-class activation mapping according to the feature map of the highest level.

In addition, when the preset range does not include the maximum response value, it may be considered that the weight enhancement is performed on the feature having the second significant association with the image classification in the feature map. At this time, there is a case where the first-class activation mapping does not contain the feature region having the highest association with the image classification, and the first-class activation mapping may be compensated and calibrated by the second-class activation mapping which may reflect the feature region with the highest association with image classification, and a more accurate image segmentation label may be obtained.

In addition, training steps for the first branch network and the second branch network are also described. By training both branches with the loss between the first-class activation mapping and the second-class activation mapping of the sample image, the information of the two branches can be fully exploited while avoiding background regions of the first-class activation mapping that are not important to focus on.

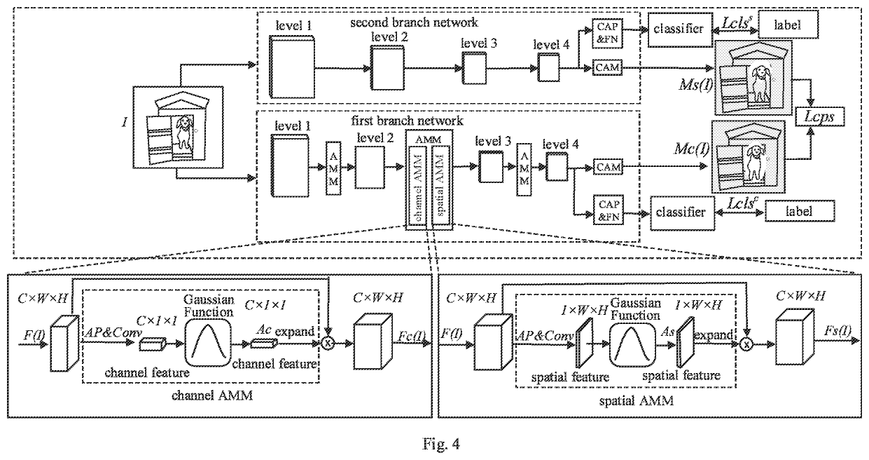

FIG. 4 schematically illustrates determining a segmentation label in an image segmentation label generation method according to Embodiment 3 of the present disclosure. Referring to FIG. 4, in some implementations, the original image I may be down-sampled by at least one level (e.g., stage 1-4 levels), resulting in at least one level of feature maps (e.g., stage 1-4 levels of feature maps).

For stage 1-3 level feature maps, feature map may be reconstructed by an Attention Modulation Module (AMM), and the AMM may include channel AMM and/or spatial AMM. Using feature map of stage 2 level as an example, AMM to reconstruct the feature map may include both channel AMM and spatial AMM in series, and it may be considered that feature maps may be processed sequentially by channel AMM and spatial AMM. The processing in which the feature map is subjected to channel AMM may be the same as the processing disclosed in FIG. 3 for reconstructing the feature map F_{c}(I) from the feature map F(I); the reconstructed feature map output from the channel AMM is subjected to the spatial AMM processing as disclosed in (b) of FIG. 3, but the feature map F_{c}(I) output from the channel AMM may be taken as the feature map F(I) input to the spatial AMM, that is, Fₛ(I) may be calculated in the following formula: Aₛ= [symbol] (H(P_{c}(F_{c}(I)))), Fₛ(I)=Ãₛ⊙F_{c}(I), where each letter represents the meaning referred to above.

Referring again to FIG. (4), taking the example that the current level is the stage 2 level, after reconstructing the feature map of the current level, the method further includes following steps.

Firstly, determining the feature map of the next level according to the reconstructed feature map Fₛ(I) of the current level. For example, downsampling may be performed on the Fₛ(I) to obtain a feature map of stage 3 level.

Secondly, reconstructing the feature map of the next level as the feature map of the new current level until determining the feature map of the highest level. For example, the feature map of stage 3 level is similarly subjected to channel AMM and spatial AMM in sequence to obtain the reconstructed feature map, and down-sampled to obtain the feature map of stage 4 level, i.e., the feature map of the highest level.

Accordingly, determining the first-class activation mapping based on the reconstructed feature map may include: determining the first-class activation mapping based on the feature map of the highest level. For example, the feature map of stage 4 level is processed by a class activation map determination module (denoted CAM in the figure), resulting in the first-class activation mapping M_{c}(I).

In these implementations, the accuracy rate of the first-class activation mapping can be improved by reconstructing the feature map in the channel dimension and/or the spatial dimension level-by-level, resulting in a feature map at the highest level, and determining the first-class activation mapping according to the feature map at the highest level.

In some implementations, the maximum value of the preset range is less than the maximum value of the feature response map. Exemplarily, assuming that the maximum value of the response values in the feature response map is 5, the preset range may be (2, 3). When the maximum value of the preset range is smaller than the maximum value of the response value, it may be considered that the weight enhancement may be applied to the feature in the feature map having the second highest association with the image classification after increasing the response value of the preset range. At this time, there is a case where the first-class activation mapping does not contain a feature region having the highest association with the image classification.

Referring to FIG. 4 again, in this case, determining the image segmentation label according to the first-class activation mapping may include: determining a second-class activation mapping according to the feature map. For example, the original image I may be downsampled at least one level (e.g., stage 1-4 levels), with feature maps at intermediate levels not being reconstructed by AMM during downsampling. The feature map of the highest level, i.e. the feature map of stage 4, may be processed by the class activation map determination module (CAM) to obtain a second-class activation mapping Mₛ(I).

Accordingly, an image segmentation label may be determined based on the first-class activation mapping M_{c}(I) and the second-class activation mapping Mₛ(I). Since the second-class activation mapping Mₛ(I) may embody feature regions that are most highly associated with the image classification, the first-class activation mapping M_{c}(I) may be compensated and calibrated by using the second-class activation mapping Mₛ(I) to obtain an image segmentation label. Illustratively, the image segmentation label M_{w}(I) may be calculated based on the following formula:

$${M}_{W} ( I ) = ξ {M}_{S} ( I ) + ( 1 - ξ ) {M}_{C} ( I )$$

where ξ may represent a calibration coefficient and may be pre-set according to empirical or experimental values.

In these implementations, when the preset range does not include the maximum value of the response value, it may be considered that the feature having the second significant association with the image classification in the feature map are weighted. At this time, there is a case where the first-class activation mapping does not contain the feature region having the highest association with the image classification, and the first-class activation mapping can be compensated and calibrated by the second-class activation mapping which may reflect the feature region with the highest association with image classification, and a more accurate image segmentation label may be obtained.

Referring next to FIG. 4, in some implementations, the first-class activation mapping M_{c}(I) is determined based on a first branch network and the second-class activation mapping Mₛ(I) is determined based on a second branch network.

The second branch network may be similar to a conventional feature map extraction network and may use a basic classification network as a backbone. The first branch network may be considered as a plug-and-play network and may be embedded in any second branch network used for image classification. By designing the AMM module in the first branch network, the response values in the feature response map may be reordered, enabling feature redistribution in channel and/or spatial dimension, mining out features that are highly associated with image segmentation but are easily ignored by the neural network for image classification. The M_{c}(I) generated by the first branch network is capable of providing more specific semantic segmentation information for the Mₛ(I) generated by the second branch network, which solves the problem of incomplete coverage of objects when CAM for image classification task is used for image segmentation task.

Accordingly, the first branch network and the second branch network may be trained based on the following steps:
acquiring a sample image, and a classification label for the sample image; taking a loss between a predicted classification of the sample image output by the first branch network and the classification label as a first loss; taking a loss between a predicted classification of the sample image output by the second branch network and the classification label as a second loss; taking a loss between a first-class activation mapping of the sample image output by the first branch network and the second-class activation mapping of the sample image output by the second branch network as a third loss; training the first branch network and the second branch network according to the first loss, the second loss, and the third loss.

Referring finally to FIG. 4, the feature map of the highest level in the first branch network and the second branch network may be processed through Global Average Pooling (GAP) and Full connection layer (FN) to obtain a feature vector, and the feature vector may be input to a Classifier to obtain a predicted classification. In turn, the loss [symbol] between the predicted classification for the sample image output by the first branch network and the classification Label (Label) may be taken as a first loss; the loss [symbol] between the predicted classification for the sample image output by the second branch network and the classification Label (Label) may be taken as the second loss. Therein, the first loss and the second loss may be calculated based on a first preset loss function, and the preset loss function may be, for example, a Multi-table soft margin loss function, or may be another function that can calculate the loss between the feature vectors.

When the first preset loss function is the multi-label soft boundary loss function, the first loss [symbol] and the second loss [symbol] may be calculated based on the following formula:

$${ℒ}_{c} = - \frac{1}{M} {\sum }_{i = 1}^{N} ( \tilde{{Y}_{i}} log ( \frac{1}{1 + {e}^{- {Y}_{i}}} ) + ( 1 - \tilde{{Y}_{i}} ) log ( \frac{{e}^{- {Y}_{i}}}{1 + {e}^{- {Y}_{i}}} ) )$$

where [symbol] _{c} may represent the first loss or the second loss; M may represent the total number of activation values in the first-class activation mapping or the second-class activation mapping; N may represent the total number of classes of the image classification, i may represent the current class; \tilde{Y}ᵢ may represent the classification label of i, Yᵢ may represent the predicted classification output by the first branch network or the second branch network.

A loss between the first-class activation mapping M_{c}(I) of the sample image output by the first branch network and the second-class activation mapping Mₛ(I) of the sample image output by the second branch network may be calculated based on a second preset loss function. The second preset loss function may be, for example, a cross-pseudo-supervised loss function, but may also be another function for calculating the loss between images.

When the second preset loss function is a cross-pseudo-supervised loss function, the third loss may be calculated based on a formula [symbol] _{cps}=∥Mₛ(I)−M_{c}(I)∥₁, where the third loss may be considered as a regularity of semantic similarity. By computing the cross-pseudo-supervised loss function, it is possible to avoid that the first-class activation mapping is concerned with background region that is less relevant to image segmentation, on the basis of making full use of the semantic information from the two branch for class activation map refinement.

Training the first branch network and the second branch network according to the first loss, the second loss, and the third loss may include:
firstly, calculating a total classification loss [symbol] _{cls} of the first loss [symbol] and the second loss [symbol] based on a formula

$${ℒ}_{cls} = \frac{1}{2} ( {ℒ}_{cls}^{s} + {ℒ}_{cls}^{c} ) ;$$

secondly, calculating a total training loss [symbol] ₐₗₗ of the total classification loss [symbol] _{cls} and the third loss [symbol] _{cps} based on the formula [symbol] ₐₗₗ= [symbol] _{cls}+ [symbol] _{cps}; finally, training the first branch network and the second branch network according to [symbol] ₐₗₗ.

In the technical solution of the embodiment of the present disclosure, the first-class activation mapping and the generation step of the image segmentation label are described in detail. The accuracy rate of the first-class activation mapping can be improved by reconstructing the feature map in the channel dimension and/or the spatial dimension level-by-level to obtain the feature map of the highest level, and determining the first-class activation mapping according to the feature map of the highest level. In addition, when the preset range does not include the maximum value of the response value, it may be considered that the weight enhancement is performed on the feature having the second highest association with the image classification in the feature map. At this time, there is a case where the first-class activation mapping does not contain the feature region having the highest association with the image classification, and the first-class activation mapping can be compensated and calibrated by the second-class activation mapping which may reflect the feature region with the highest association with image classification, and a more accurate image segmentation label may be obtained. Moreover, the training steps of the first branch network and the second branch network are also described in detail. By using the loss between the first-class activation mapping and the second-class activation mapping of the sample image to train the two branches, making full use of the information of the two branches and avoiding paying attention to unimportant background region in the first-class activation mapping.

The image segmentation label generation method provided by the embodiments of the present disclosure belongs to the same concept as the image segmentation label generation method provided by the embodiments described above, technical details that are not elaborately described in the present embodiment may be referred to the embodiments described above, and the same technical features have the same effects in the present embodiment and the embodiments described above.

### Embodiment 4

FIG. 5 is a schematic diagram illustrating an image segmentation label generation apparatus according to Embodiment 4 of the present disclosure. The image segmentation label generation apparatus provided by the present embodiment is applicable to a case where the image segmentation label is generated, particularly to a case where the image segmentation label is generated from the class activation map.

As shown in FIG. 5, the image segmentation label generation apparatus may include:
a response map determination module 510, configured for acquiring a feature map of an original image, determining a feature response map of the feature map, wherein a response value in the feature response map represents a weight of a corresponding feature in the feature map in image classification; a feature map reconstruction module 520 configured for increasing a response value within a preset range in the feature response map, reconstructing the feature map according to a feature response map with the increased response value; a segmentation label determination module 530, configured for determining a first-class activation mapping based on the reconstructed feature map, and determining an image segmentation label according to the first-class activation mapping.

In some embodiments, the response map determination module 510 may be configured for:
subjecting the feature map to global average pooling and convolution processing in a spatial dimension to obtain a first feature response map in a channel dimension; or, subjecting the feature map to global average pooling and convolution processing in the channel dimension to obtain a second feature response map in the spatial dimension.

In some embodiments, if the feature response map is the first feature response map, the response map determination module 510 may be configured for: determining a third feature response map in the spatial dimension corresponding to the reconstructed feature map; increasing a response value within the preset range in the third feature response map, reconstructing the reconstructed feature map again based on the third feature response map with the increased response value; determining the first-class activation mapping based on the again reconstructed feature map.

In some embodiments, if the feature response map is the second feature response map, the response map determination module 510 may be configured for: determining a fourth feature response map in the channel dimension corresponding to the reconstructed feature map; increasing a response value within the preset range in the fourth feature response map, reconstructing the reconstructed feature map again based on the fourth feature response map with the increased response value; determining the first-class activation mapping based on the again reconstructed feature map.

In some embodiments, the feature map reconstruction module 520 may be configured for:
modulating the feature response map based on a preset modulation function to increase the response value within the preset range in the feature response map.

In some embodiments, the feature map reconstruction module 520 may be configured for:
expanding the feature response map with the increased response value to a same resolution as the feature map; performing pixel-level multiplication on a feature response map with the increased response value after expanding resolution and the feature map.

In some embodiments, the feature map comprises a feature map of at least one level. Correspondingly, after reconstructing a feature map of a current level, the response map determination module 510 may be further configured for: determining a feature map of a next level based on a reconstructed feature map of the current level. Correspondingly, the feature map reconstruction module 520 may be further configured for: taking the feature map of the next level as a new feature map of the current level to reconstruct, until determining a feature map of a highest level. The segmentation label determination module 530 may be configured for: determining the first-class activation mapping based on the feature map of the highest level.

In some embodiments, a maximum value of the preset range is smaller than a maximum value of the feature response map, the segmentation label determination module 530 may be configured for:
determining a second-class activation mapping according to the feature map; determining the image segmentation label according to the first-class activation mapping and the second-class activation mapping.

In some embodiments, the first-class activation mapping is determined based on a first branch network and the second-class activation mapping is determined based on a second branch network. Correspondingly, the image segmentation label generation apparatus may further include:
a training module, configured for training the first branch network and the second branch network based on following steps:
acquiring a sample image and a classification label for the sample image; taking a loss between a predicted classification for the sample image output by the first branch network and the classification label as a first loss; taking a loss between a predicted classification for the sample image output by the second branch network and the classification label as a second loss; taking a loss between a first-class activation mapping for the sample image output by the first branch network and a second-class activation mapping for the sample image output by the second branch network as a third loss; training the first branch network and the second branch network according to the first loss, the second loss, and the third loss.

The generation of the image segmentation label provided by the embodiment of the present disclosure is apparatus to perform the method of generating the image segmentation label provided by any of the embodiments of the present disclosure, and has functional modules and effects corresponding to the method of performing.

The plurality of units and modules included in the apparatus are divided only according to the function logic, but are not limited to the above-described division as long as the corresponding functions can be realized; In addition, the names of the plurality of functional units are also merely for convenience of distinguishing from each other, and are not used to limit the protection scope of the embodiments of the present disclosure.

### Embodiment 5

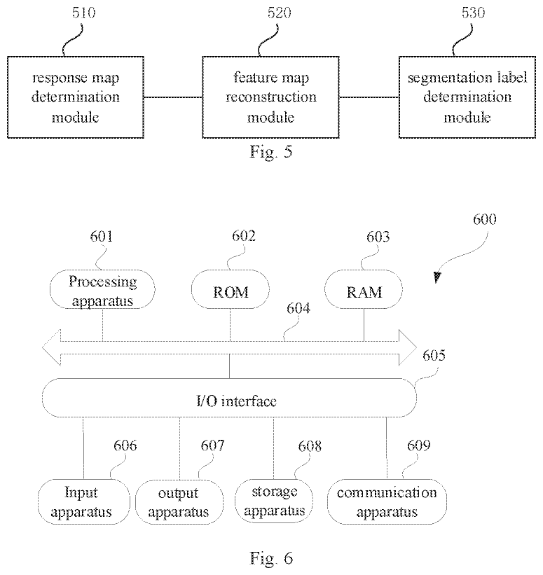

Reference is now made to FIG. 6, which shows a structural schematic diagram of an electronic device (for example, a terminal device or a server in FIG. 6) 600 suitable for implementing an embodiment of the present disclosure. The terminal devices in the embodiments of the present disclosure may include, but not limited to, mobile terminals such as a mobile phone, a notebook computer, a digital broadcast receiver, a personal digital assistant (Personal Digital Assistant, PDA), a tablet computer (Portable Android Device, PAD), a portable multimedia player (Portable Media Player, PMP), a vehicle-mounted terminal (for example, a vehicle-mounted navigation terminal) and the like, and fixed terminals such as a digital TV, a desktop computer and the like. The electronic device 600 shown in FIG. 6 is only an example, and should not bring any limitation to the functions and application scope of the embodiments of the present disclosure.

As shown in FIG. 6, the electronic device 600 may include a processing apparatus (for example, a central processing unit, a graphics processing unit, etc.) 601, which may perform various appropriate actions and processes according to programs stored in a read-only memory (Read-Only Memory, ROM) 602 or programs loaded from a storage apparatus 608 into a random-access memory (Random Access Memory, RAM) 603. In the RAM 603, various programs and data required for operations of the electronic device 600 are also stored. The processing apparatus 601, the ROM 602 and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, a liquid crystal display (Liquid Crystal Display, LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. While the electronic device 600 with various apparatuses is shown in FIG. 6, it should be understood that it is not required to implement or have all the apparatuses shown. More or fewer apparatuses may alternatively be implemented or provided.

According to the embodiments of the present disclosure, processes described above with reference to the flowchart may be implemented as a computer software program. For example, an embodiment of the present disclosure includes a computer program product, which includes a computer program carried on a non-transitory computer-readable medium, the computer program including program codes for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above functions defined in the image segmentation label generation method of the embodiment of the present disclosure are performed.

The electronic device provided by the embodiment of the present disclosure belongs to the same disclosed concept as the image segmentation label generation method provided by the embodiment above, technical details that are not described in detail in the present embodiment can be referred to the embodiments above, and the present embodiment has the same advantageous effects as the embodiments above.

### Embodiment 6

An embodiment of the present disclosure provides a computer storage medium having stored thereon a computer program, which, when executed by a processor, implement the image segmentation label generation method provided in the embodiment above.

It should be noted that the computer-readable medium mentioned above in the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM) or flash memory, an optical fiber, a portable compact disk read-only memory (CD-ROM), an optical storage device, a magnetic storage device, or any suitable combination of the above. In the present disclosure, the computer-readable storage medium may be any tangible medium containing or storing a program, which program may be used by or in combination with an instruction execution system, apparatus or device. In the present disclosure, the computer-readable signal medium may include a data signal propagated in a baseband or as part of a carrier wave, in which computer-readable program codes are carried. This propagated data signal may take multiple forms, including but not limited to electromagnetic signals, optical signals or any suitable combination of the above. The computer-readable signal medium may also be any computer-readable medium other than the computer-readable storage medium, and may send, propagate or transmit a program used by or in combination with an instruction execution system, apparatus or device. The program codes contained in the computer-readable medium may be transmitted by any suitable medium, including but not limited to: electric wires, optical cables, radio frequency (RF) and the like, or any suitable combination of the above.

In some implementations, the client and the server can communicate by using any currently known or future developed network protocol such as a hypertext transfer protocol (HTTP), and may be interconnected with digital data communication in any form or medium (for example, a communication network). Examples of the communication network include a local area network (Local Area Network, LAN), a wide area network (Wide Area Network, WAN), the Internet work (for example, the Internet) and an end-to-end network (for example, an ad hoc end-to-end network), as well as any currently known or future developed networks.

The computer-readable medium described above may be included in the electronic device; or it may exist alone without being assembled into the electronic device.

The computer-readable medium carries one or more programs which, when executed by the electronic device, cause the electronic device to:
acquire a feature map of an original image, determine a feature response map of the feature map; increase a response value within a preset range in the feature response map, reconstruct the feature map according to the feature response map with the increased response value; determine a first-class activation mapping based on a reconstructed feature map, and determine an image segmentation label according to the first-class activation mapping.

Computer program codes for performing the operations of the present disclosure may be written in one or more programming languages or combinations thereof, including but not limited to object-oriented programming languages such as Java, Smalltalk and C++, and conventional procedural programming languages such as “C” or similar programming languages. The program codes may be completely executed on a user computer, partially executed on the user computer, executed as an independent software package, partially executed on the user computer and partially executed on a remote computer, or completely executed on the remote computer or a server. In the case involving the remote computer, the remote computer may be connected to the user computer through any type of network, including a local area network (LAN) or a wide area network (WAN), or may be connected to an external computer (for example, through the Internet using an Internet service provider).

The flowchart and block diagrams in the drawings illustrate architectures, functions and operations of possible implementations of the systems, methods and the computer program product according to various embodiments of the present disclosure. In this regard, each block in the flowchart or block diagram may represent a part of a module, a program segment, or codes, which includes one or more executable instructions for implementing specified logical functions. It is also noted that, in some alternative implementations, the functions noted in the block may occur out of the order noted in the figures. For example, two blocks shown in succession may, in fact, be executed substantially in parallel, and may sometimes be executed in the reverse order, depending on the functions involved. It is also noted that each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. The name of the unit does not constitute a limitation on the unit itself in some cases.

The functions described above herein may be at least partially performed by one or more hardware logic components. For example, without limitation, exemplary types of hardware logic components that may be used include: a field programmable gate array (Field Programmable Gate Array, FPGA), an application-specific integrated circuit (Application Specific Integrated Circuit, ASIC), an application specific standard product (Application Specific Standard Parts, ASSP), a system-on-chip (System on Chip, SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, Example 1 provides an image segmentation label generation method, including:
acquiring a feature map of an original image, determining a feature response map of the feature map, wherein a response value in the feature response map represents a weight of a corresponding feature in the feature map in image classification;
increasing a response value within a preset range in the feature response map, reconstructing the feature map according to a feature response map with the increased response value;
determining a first-class activation mapping based on the reconstructed feature map, and determining an image segmentation label according to the first-class activation mapping.

According to one or more embodiments of the present disclosure, Example 2 provides an image segmentation label generation method, including:
in some implementations, determining a feature response map of the feature map, may include:
the subjecting the feature map to global average pooling and convolution processing in a spatial dimension to obtain a first feature response map in a channel dimension; or,
subjecting the feature map to global average pooling and convolution processing in the channel dimension to obtain a second feature response map in the spatial dimension.

According to one or more embodiments of the present disclosure, Example 3 provides an image segmentation label generation method, including:
in some implementations, in a case where the feature response map is the first feature response map, the determining a first-class activation mapping based on the reconstructed feature map, includes:
determining a third feature response map in the spatial dimension corresponding to the reconstructed feature map;
increasing a response value within the preset range in the third feature response map, reconstructing the reconstructed feature map again based on the third feature response map with the increased response value;
determining the first-class activation mapping based on the again reconstructed feature map.

According to one or more embodiments of the present disclosure, Example 4 provides an image segmentation label generation method, including:
in some implementations, in a case where the feature response map is the second feature response map, the determining a first-class activation mapping based on the reconstructed feature map, includes:
determining a fourth feature response map in the channel dimension corresponding to the reconstructed feature map;
increasing a response value within the preset range in the fourth feature response map, reconstructing the reconstructed feature map again based on the fourth feature response map with the increased response value;
determining the first-class activation mapping based on the again reconstructed feature map.

According to one or more embodiments of the present disclosure, Example 5 provides an image segmentation label generation method, including:
in some implementations, the increasing a response value within a preset range in the feature response map, includes:
modulating the feature response map based on a preset modulation function to increase the response value within the preset range in the feature response map.

According to one or more embodiments of the present disclosure, Example 6 provides an image segmentation label generation method, including:
in some implementations, reconstructing the feature map according to the feature response map with the increased response value, includes:
expanding the feature response map with the increased response value to a same resolution as the feature map;
performing pixel-level multiplication on a feature response map with the increased response value after expanding resolution and the feature map.

According to one or more embodiments of the present disclosure, Example 7 provides an image segmentation label generation method, including:
in some implementations, the feature map comprises a feature map of at least one level, correspondingly, after reconstructing a feature map of a current level, further including:
determining a feature map of a next level based on a reconstructed feature map of the current level;
taking the feature map of the next level as a new feature map of the current level to reconstruct, until determining a feature map of a highest level;
the determining a first-class activation mapping based on the reconstructed feature map, including: determining the first-class activation mapping based on the feature map of the highest level.

According to one or more embodiments of the present disclosure, Example 8 provides an image segmentation label generation method, including:
in some implementations, a maximum value of the preset range is smaller than a maximum value of the feature response map;
the determining an image segmentation label according to the first-class activation mapping, includes:
determining a second-class activation mapping according to the feature map;
determining the image segmentation label according to the first-class activation mapping and the second-class activation mapping.

According to one or more embodiments of the present disclosure, Example 9 provides an image segmentation label generation method, including:
in some implementations, the first-class activation mapping is determined based on a first branch network and the second-class activation mapping is determined based on a second branch network;
the first branch network and the second branch network are trained based on following steps:
acquiring a sample image and a classification label for the sample image;
taking a loss between a predicted classification for the sample image output by the first branch network and the classification label as a first loss;
taking a loss between a predicted classification for the sample image output by the second branch network and the classification label as a second loss;
taking a loss between a first-class activation mapping for the sample image output by the first branch network and a second-class activation mapping for the sample image output by the second branch network as a third loss;
training the first branch network and the second branch network according to the first loss, the second loss, and the third loss.

Furthermore, although various operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

1. An image segmentation label generation method, comprising:
acquiring a feature map of an original image, determining a feature response map of the feature map, wherein a response value in the feature response map represents a weight of a corresponding feature in the feature map in image classification;
increasing a response value within a preset range in the feature response map, reconstructing the feature map according to a feature response map with the increased response value to obtain a first reconstructed feature map;
determining a first-class activation mapping based on the first reconstructed feature map, and determining an image segmentation label according to the first-class activation mapping.

2. The method according to claim 1, wherein the determining a feature response map of the feature map, comprises:
subjecting the feature map to global average pooling and convolution processing in a spatial dimension to obtain a first feature response map in a channel dimension; or,
subjecting the feature map to global average pooling and convolution processing in the channel dimension to obtain a second feature response map in the spatial dimension.

3. The method according to claim 2, wherein, in a case where the feature response map is the first feature response map, the determining a first-class activation mapping based on the first reconstructed feature map, comprises:
determining a third feature response map in the spatial dimension corresponding to the first reconstructed feature map;
increasing a response value within the preset range in the third feature response map, reconstructing the first reconstructed feature map again based on the third feature response map with the increased response value to obtain a second reconstructed feature map;
determining the first-class activation mapping based on the second reconstructed feature map.

4. The method according to claim 2, wherein, in a case where the feature response map is the second feature response map, the determining a first-class activation mapping based on the first reconstructed feature map, comprises:
determining a fourth feature response map in the channel dimension corresponding to the first reconstructed feature map;
increasing a response value within the preset range in the fourth feature response map, reconstructing the first reconstructed feature map again based on the fourth feature response map with the increased response value to obtain a third reconstructed feature map;
determining the first-class activation mapping based on the third reconstructed feature map.

5. The method according to claim 1, wherein the increasing a response value within a preset range in the feature response map, comprises:
modulating the feature response map based on a preset modulation function to increase the response value within the preset range in the feature response map.

6. The method according to claim 1, wherein reconstructing the feature map according to the feature response map with the increased response value to obtain a first reconstructed feature map, comprises:
expanding the feature response map with the increased response value to a same resolution as the feature map to obtain an extended feature response map;
performing pixel-level multiplication on the extended feature response map and the feature map.

7. The method according to claim 1, wherein the feature map comprises a feature map of at least one level,
after reconstructing a feature map of a current level, the method further comprises:
determining a feature map of a next level based on a reconstructed feature map of the current level;
taking the feature map of the next level as a new feature map of the current level to reconstruct, until determining a feature map of a highest level;
the determining a first-class activation mapping based on the first reconstructed feature map, comprises:
determining the first-class activation mapping based on the feature map of the highest level.

8. The method according to claim 1, wherein a maximum value of the preset range is smaller than a maximum value of the feature response map,
the determining an image segmentation label according to the first-class activation mapping, comprises:
determining a second-class activation mapping according to the feature map;
determining the image segmentation label according to the first-class activation mapping and the second-class activation mapping.

9. The method according to claim 8, wherein the first-class activation mapping is determined based on a first branch network and the second-class activation mapping is determined based on a second branch network;
training the first branch network and the second branch network, comprises:
acquiring a sample image and a classification label for the sample image;
taking a loss between a predicted classification for the sample image output by the first branch network and the classification label as a first loss;
taking a loss between a predicted classification for the sample image output by the second branch network and the classification label as a second loss;
taking a loss between a first-class activation mapping for the sample image output by the first branch network and a second-class activation mapping for the sample image output by the second branch network as a third loss;
training the first branch network and the second branch network according to the first loss, the second loss, and the third loss.

10. An image segmentation label generation apparatus, comprising:
a response map determination module, configured for acquiring a feature map of an original image, determining a feature response map of the feature map, wherein a response value in the feature response map represents a weight of a corresponding feature in the feature map in image classification;
a feature map reconstruction module, configured for increasing a response value within a preset range in the feature response map, reconstructing the feature map according to a feature response map with the increased response value to obtain a first reconstructed feature map;
a segmentation label determination module, configured for determining a first-class activation mapping based on the first reconstructed feature map, and determining an image segmentation label according to the first-class activation mapping.

11. An electronic device, comprising:
at least one processor;
a storage apparatus configured to store the at least one program;
wherein the at least one program, when executed by the at least one processor, causes the electronic device to:
acquire a feature map of an original image, determine a feature response map of the feature map, wherein a response value in the feature response map represents a weight of a corresponding feature in the feature map in image classification;
increase a response value within a preset range in the feature response map, reconstructing the feature map according to a feature response map with the increased response value to obtain a first reconstructed feature map;
determine a first-class activation mapping based on the first reconstructed feature map, and determining an image segmentation label according to the first-class activation mapping.

12. A storage medium comprising computer-executable instructions which, when executed by a computer processor, configured to perform the image segmentation label generation method according to claim 1.

13. The electronic device according to claim 11, wherein the one or more processors, further cause the electronic device to:
subject the feature map to global average pooling and convolution processing in a spatial dimension to obtain a first feature response map in a channel dimension; or,
subject the feature map to global average pooling and convolution processing in the channel dimension to obtain a second feature response map in the spatial dimension.

14. The electronic device according to claim 13, wherein, in a case where the feature response map is the first feature response map, the one or more processors, further cause the electronic device to:
determine a third feature response map in the spatial dimension corresponding to the first reconstructed feature map;
increase a response value within the preset range in the third feature response map, reconstruct the first reconstructed feature map again based on the third feature response map with the increased response value to obtain a second reconstructed feature map;
determine the first-class activation mapping based on the second reconstructed feature map.

15. The electronic device according to claim 13, wherein, in a case where the feature response map is the second feature response map, the one or more processors, further cause the electronic device to:
determine a fourth feature response map in the channel dimension corresponding to the first reconstructed feature map;
increase a response value within the preset range in the fourth feature response map, reconstruct the first reconstructed feature map again based on the fourth feature response map with the increased response value to obtain a third reconstructed feature map;
determine the first-class activation mapping based on the third reconstructed feature map.

16. The electronic device according to claim 11, wherein the one or more processors, further cause the electronic device to:
modulate the feature response map based on a preset modulation function to increase the response value within the preset range in the feature response map.

17. The electronic device according to claim 11, wherein the one or more processors, further cause the electronic device to:
expand the feature response map with the increased response value to a same resolution as the feature map to obtain an extended feature response map;
perform pixel-level multiplication on the extended feature response map and the feature map.

18. The electronic device according to claim 11, wherein the feature map comprises a feature map of at least one level,
after reconstructing a feature map of a current level, the one or more processors, further cause the electronic device to:
determine a feature map of a next level based on a reconstructed feature map of the current level;
take the feature map of the next level as a new feature map of the current level to reconstruct, until determining a feature map of a highest level;
when the electronic device is caused to determine a first-class activation mapping based on the first reconstructed feature map, the electronic device is configured to:
determine the first-class activation mapping based on the feature map of the highest level.

19. The electronic device according to claim 11, wherein a maximum value of the preset range is smaller than a maximum value of the feature response map,
the one or more processors, further cause the electronic device to:
determine a second-class activation mapping according to the feature map;
determine the image segmentation label according to the first-class activation mapping and the second-class activation mapping.

20. The electronic device according to claim 19, wherein the first-class activation mapping is determined based on a first branch network and the second-class activation mapping is determined based on a second branch network;
the one or more processors, further cause the electronic device to:
take a loss between a predicted classification for the sample image output by the first branch network and the classification label as a first loss;
take a loss between a predicted classification for the sample image output by the second branch network and the classification label as a second loss;
take a loss between a first-class activation mapping for the sample image output by the first branch network and a second-class activation mapping for the sample image output by the second branch network as a third loss;
train the first branch network and the second branch network according to the first loss, the second loss, and the third loss.
